(19) United States
(12) Patent Application Publication
(10) Pub. No.: US 2023/0264400 A1
(43) Pub. Date: Aug. 24, 2023

(54) MOLD CLAMPING APPARATUS AND INJECTION MOLDING MACHINE

(71) Applicant: THE JAPAN STEEL WORKS, LTD., Tokyo (JP)

(72) Inventor: Yusuke YONEHARA, Tokyo (JP)

(21) Appl. No.: 18/105,645

(22) Filed: Feb. 3, 2023

(30) Foreign Application Priority Data
Feb. 22, 2022 (JP) 2022-025373

(51) Int. Cl. B29C 45/66

(52) U.S. Cl. CPC B29C 45/661; B29C 2045/665

(57) ABSTRACT

A mold clamping apparatus includes a mold clamping mechanism having a screw shaft, a crosshead, and a cylindrical cover member configured to house the screw shaft. The cover member includes a rear cover member arranged between a mold clamping housing and the crosshead and a front cover member arranged between the crosshead and a movable platen, and the rear cover member expands and contracts in accordance with change in a facing distance between the mold clamping housing and the crosshead caused by movement of the crosshead.

### CROSS-REFERENCE TO RELATED APPLICATION

The present application claims priority from Japanese Patent Application No. 2022-025373 filed on Feb. 22, 2022, the contents of which are hereby incorporated by reference into this application.

### TECHNICAL FIELD OF THE INVENTION

The present invention relates to a mold clamping apparatus and an injection molding machine.

### BACKGROUND OF THE INVENTION

An injection molding machine configured to manufacture a resin member or a metal member with a desired shape has been known. A general injection molding machine includes a mold clamping apparatus and an injection apparatus. The mold clamping apparatus holds molds and opens and closes the held molds. The injection apparatus melts a resin material or a metal material and supplies the molten material to the mold clamping apparatus.

The mold clamping apparatus has a mold clamping mechanism configured to open and close the molds, and the mold clamping mechanism is provided with a ball screw that converts rotary motion into linear motion (see Japanese Unexamined Patent Application Publication No. 2005-035270 (Patent Document 1)).

### SUMMARY OF THE INVENTION

A ball screw provided in the mold clamping mechanism includes a screw shaft arranged near the mold. From another point of view, the screw shaft is used in an environment where there is a risk of adhesion of foreign matters such as mold release agent, burrs, and resin powder.

Other objects and novel features will be apparent from the description of this specification and the accompanying drawings.

A mold clamping mechanism provided in a mold clamping apparatus according to one embodiment includes a screw shaft and a cylindrical cover member that houses the screw shaft. The cover member includes a cover member arranged between a mold clamping housing and a crosshead and a cover member arranged between the crosshead and a movable platen. The cover member arranged between the mold clamping housing and the crosshead expands and contracts in accordance with a change in a facing distance between the mold clamping housing and the crosshead caused by the movement of the crosshead.

According to one embodiment, it is possible to prevent the reduction in life and the breakage of the screw shaft constituting the ball screw provided in the mold clamping mechanism.

### BRIEF DESCRIPTIONS OF THE DRAWINGS

FIG. 1 is a schematic diagram showing an injection molding machine according to an embodiment;

FIG. 2 is a schematic diagram showing a part of the injection molding machine shown in FIG. 1;

FIG. 3A is a partial cross-sectional view of a ball screw and its surroundings shown in FIG. 1;

FIG. 3B is a partial cross-sectional view of the ball screw and its surroundings shown in FIG. 2;

FIG. 4 is an explanatory diagram showing a rear cover member;

FIG. 5 is a plan view showing a front surface of a mold clamping housing;

FIG. 6 is a plan view showing a back surface of a crosshead;

FIG. 7 is a cross-sectional view schematically showing a support member; and

FIG. 8 is a partial perspective view showing the support member.

### DESCRIPTIONS OF THE PREFERRED EMBODIMENTS

Hereinafter, an embodiment will be described in detail with reference to drawings. Note that the members and devices having the same or substantially same function are denoted by the same reference characters throughout the drawings for describing the embodiment, and the repetitive description thereof will be omitted.

<Injection Molding Machine>

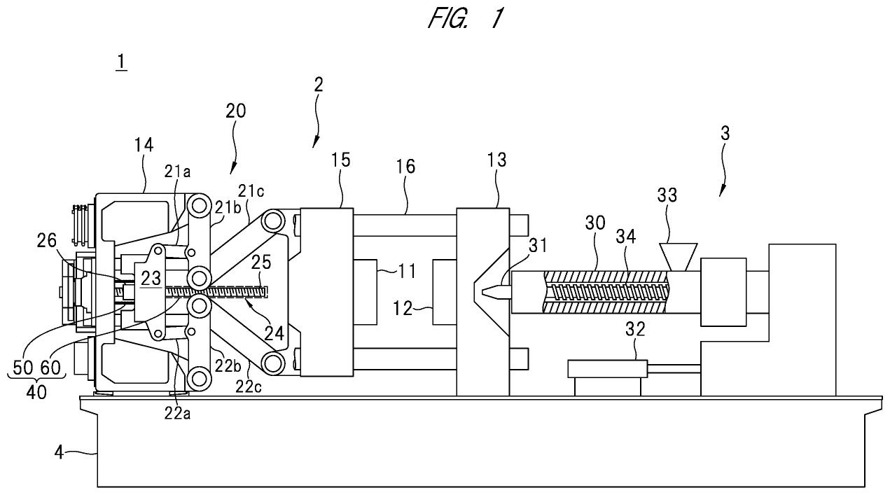

FIG. 1 is a schematic diagram showing an injection molding machine 1 according to the present embodiment. The injection molding machine 1 includes a mold clamping apparatus 2 and an injection apparatus 3. Molds 11 and 12 are attached to the mold clamping apparatus 2. The mold clamping apparatus 2 opens and closes the attached molds 11 and 12. The injection apparatus 3 heats and melts a metal material (for example, magnesium or magnesium alloy). The injection apparatus 3 injects the molten metal material (molten metal) into the molds 11 and 12 attached to the mold clamping apparatus 2. More specifically, the injection apparatus 3 injects the molten metal into a cavity of the molds 11 and 12. Namely, the injection molding machine 1 according to the present embodiment is a metal injection molding machine.

<Mold Clamping Apparatus>

The mold clamping apparatus 2 includes a fixed platen 13, a mold clamping housing 14, and a movable platen 15 provided on a bed 4. The fixed platen 13 and the mold clamping housing 14 are fixed to the bed 4. On the other hand, the movable platen 15 is slidable above the bed 4.

The fixed platen 13 and the mold clamping housing 14 are connected to each other by a plurality of tie bars 16 passing through the movable platen 15. More specifically, the fixed platen 13 and the mold clamping housing 14 are connected by four tie bars 16. The movable platen 15 is slidable between the fixed platen 13 and the mold clamping housing 14 in the opposing direction thereof.

A mold clamping mechanism 20 is provided between the mold clamping housing 14 and the movable platen 15. More specifically, the link-type mold clamping mechanism 20 is provided between the mold clamping housing 14 and the movable platen 15. From another point of view, a toggle mechanism is provided between the mold clamping housing 14 and the movable platen 15.

The mold clamping mechanism 20 moves the mold 11 attached to the movable platen 15 forward and backward with respect to the mold 12 attached to the fixed platen 13. When the mold 11 comes in contact with the mold 12, the molds 11 and 12 are closed. On the other hand, when the mold 11 is separated from the mold 12, the molds 11 and 12 are opened. The mold clamping mechanism 20 can press the mold 11 to the mold 12 such that the molds 11 and 12 do not open while the molds 11 and 12 are closed.

<Injection Apparatus>

The injection apparatus 3 includes a heating cylinder 30, an injection nozzle 31, and the like provided on the bed 4. The injection apparatus 3 is driven by a nozzle touch device 32 not only in a direction toward the mold clamping apparatus 2 (forward direction) but also in a direction away from the mold clamping apparatus 2 (backward direction). In other words, the injection apparatus 3 moves forward and backward with respect to the mold clamping apparatus 2. When the injection apparatus 3 moves forward to a predetermined position, a tip of the injection nozzle 31 comes in contact with a sprue bush of the mold 12.

A hopper 33 is provided on a rear end side of the heating cylinder 30. The hopper 33 is a supply port for supplying a metal material into the heating cylinder 30. A screw 34 is provided inside the heating cylinder 30. The screw 34 is driven inside the heating cylinder 30. More specifically, the screw 34 is rotationally driven inside the heating cylinder 30. Further, the screw 34 is linearly driven inside the heating cylinder 30. Note that the direction in which the screw 34 is linearly driven is the same as the moving direction of the injection apparatus 3 with respect to the mold clamping apparatus 2. Namely, the screw 34 is linearly driven inside the heating cylinder 30 in the direction toward the mold clamping apparatus 2 (forward direction) and the direction away from the mold clamping apparatus 2 (backward direction).

The heating cylinder 30 melts the supplied metal material to make molten metal. A heater for heating the heating cylinder 30 is provided around the heating cylinder 30. In the present embodiment, a plurality of band heaters are wound around the outer peripheral surface of the heating cylinder 30. The metal material supplied to the heating cylinder 30 is heated and melted by the heat generated from the band heater and the shearing heat generated by the rotation of the screw 34.

<Manufacturing Method of Molded Product>

Next, an example of a procedure (process) for manufacturing a metal member by use of the injection molding machine 1 shown in FIG. 1 will be described. First, the molds 11 and 12 attached to the mold clamping apparatus 2 are opened, and the injection apparatus 3 is moved backward.

Thereafter, the metal material is put into the hopper 33 of the injection apparatus 3. For example, magnesium powder is put into the hopper 33. Understandably, the metal material may be put into the hopper 33 in advance before the injection apparatus 3 is moved backward.

The metal material put into the hopper 33 passes through the hopper 33 and falls into the heating cylinder 30. The metal material supplied to the heating cylinder 30 is heated and melted. The molten metal material (molten metal) is sent to the tip side of the heating cylinder 30 by the rotation of the screw 34. From another point of view, the molten metal is charged between the screw 34 and the injection nozzle 31.

Thereafter, the injection apparatus 3 is moved forward to bring the tip of the injection nozzle 31 into contact with the sprue bush of the mold 12 (the molds 11 and 12 are closed in advance). Then, the screw 34 is moved forward inside the heating cylinder 30. At this time, the screw 34 is not rotated. Consequently, the molten metal is poured (injected) into the cavity of the molds 11 and 12 from the tip of the injection nozzle 31.

The screw 34 continues to apply pressure (holding pressure) to the molten metal even after the molten metal is injected into the cavity. The holding pressure is equal to or less than the pressure (injection pressure/primary pressure) for pouring (injecting) the molten metal into the cavity. The molds 11 and 12 are cooled while maintaining the state in which the holding pressure is applied to the molten metal in the cavity.

While the molds 11 and 12 are being cooled, the screw 34 is rotated again to prepare for the next injection. Specifically, the screw 34 is rotated to send the molten metal to the tip side of the heating cylinder 30. Namely, the molten metal to be injected next is charged between the screw 34 and the injection nozzle 31. As a result, the screw 34 is moved backward due to the reaction force. This process of moving the screw 34 backward while feeding the molten metal forward is referred to as “metering”.

After the molds 11 and 12 are cooled to a temperature below the temperature at which the molten metal in the cavity solidifies, the molds 11 and 12 are opened to take out the molded product.

By repeating the above process, metal members (molded products) of the same shape are continuously manufactured. Namely, metal members (molded products) having a desired shape are mass-produced. In some cases, a process of degreasing or sintering the molded product taken out from the molds 11 and 12 may be added to the above process.

<Mold Clamping Mechanism>

The mold clamping mechanism 20 provided in the mold clamping apparatus 2 is composed of links, a crosshead, a ball screw, and the like. More specifically, the mold clamping mechanism 20 includes upper links 21a, 21b, and 21c and lower links 22a, 22b, and 22c. In addition, the mold clamping mechanism 20 includes a crosshead 23 arranged between the upper links 21a, 21b, and 21c and the lower links 22a, 22b, and 22c. Further, the mold clamping mechanism 20 includes a ball screw 24 having a screw shaft 25 held rotatably and a nut member 26 screwed to the screw shaft 25.

Note that another set of similar links and a ball screw is provided behind the links and the ball screw shown in FIG. 1 (non-operation side). Namely, one set of the links and the ball screw is provided on each of an operation side and a non-operation side of the mold clamping apparatus 2. Understandably, the links and the ball screw on the operation side and the links and the ball screw on the non-operation side have the same structure. Therefore, by clarifying the structure of the links and the ball screw on the operation side shown in FIG. 1, the structure of the links and the ball screw on the non-operation side not shown in FIG. 1 will also be clarified.

<Link>

One ends (proximal ends) of the upper link 21a and the lower link 22a are rotatably connected to the crosshead 23 by pins. One ends (proximal ends) of the upper link 21b and the lower link 22b are rotatably connected to the mold clamping housing 14 by pins. One ends (proximal ends) of the upper link 21c and the lower link 22c are rotatably connected to the movable platen 15 by pins. Also, one ends (distal ends) of the upper link 21b and the lower link 22b and one ends (distal ends) of the upper link 21c and the lower link 22c are rotatably connected by pins. Further, one ends (distal ends) of the upper link 21a and the lower link 22a are rotatably connected to the center or approximately the center of the upper link 21b and the lower link 22b in the longitudinal direction, respectively.

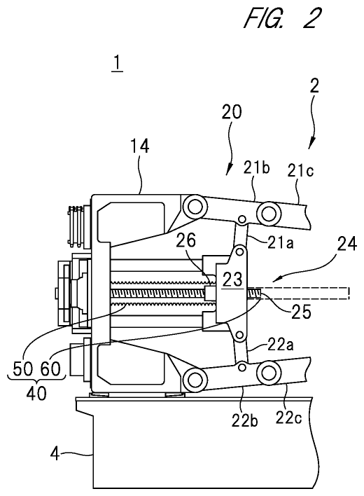

The links (upper links 21a, 21b, and 21c and lower links 22a, 22b, and 22c) expand and contract as the crosshead 23 moves. More specifically, when the crosshead 23 moves in the direction toward the mold clamping housing 14 (when the crosshead 23 moves backward), the links are contracted (bent) as shown in FIG. 1. On the other hand, when the crosshead 23 moves in the direction away from the mold clamping housing 14 (when the crosshead 23 moves forward), the links expand (extend) as shown in FIG. 2.

Further, when the links are contracted, the movable platen 15 to which the proximal ends of the upper link 21c and the lower link 22c are connected moves in the direction toward the mold clamping housing 14. As a result, the mold 11 attached to the movable platen 15 is separated from the mold 12, and the molds 11 and 12 are opened. On the other hand, when the links expand, the movable platen 15 to which the proximal ends of the upper link 21c and the lower link 22c are connected moves in the direction away from the mold clamping housing 14. As a result, the mold 11 attached to the movable platen 15 is pressed to the mold 12, and the molds 11 and 12 are closed. In other words, opening and closing of the molds 11 and 12 and clamping of the molds 11 and 12 are realized by the expansion and contraction of the links.

<Ball Screw>

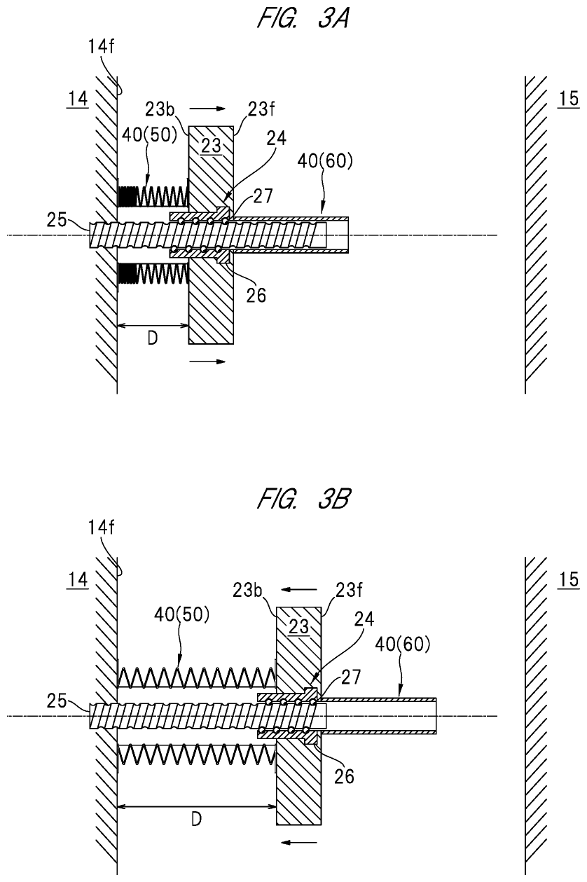

FIG. 3A is a partial cross-sectional view of the ball screw 24 and its surroundings shown in FIG. 1. FIG. 3B is a partial cross-sectional view of the ball screw 24 and its surroundings shown in FIG. 2. One end of the screw shaft 25 of the hole screw 24 is rotatably held by a bearing provided in the mold clamping housing 14. On the other hand, the other end of the screw shaft 25 is inserted through the crosshead 23.

The nut member 26 of the ball screw 24 is partially embedded in the crosshead 23 and integrated with the crosshead 23. Also, the nut member 26 is screwed to the screw shaft 25. From another point of view, the screw shaft 25 passes through the nut member 26 embedded in the crosshead 23.

Note that a plurality of balls (rolling elements) 27 are arranged between the screw shaft 25 and the nut member 26, and the balls 27 endlessly circulate between the screw shaft 25 and the nut member 26.

The screw shaft 25 is rotationally driven by a driving force input via a gear, a belt, or the like. When the screw shaft 25 rotates, the nut member 26 moves on the screw shaft 25 in the longitudinal direction (axial direction) of the screw shaft 25. As a result, the crosshead 23 integrated with the nut member 26 moves in the longitudinal direction of the screw shaft 25. Namely, the rotary motion of the screw shaft 25 is converted into the linear motion of the crosshead 23.

In the following description, the rotation direction of the screw shaft 25 that moves the crosshead 23 forward is defined as the “forward rotation direction”, and the rotation direction of the screw shaft 25 that moves the crosshead 23 backward is defined as the “reverse rotation direction”. Understandably, the definition is only for convenience of description.

According to the above definition, when the screw shaft 25 shown in FIG. 3A is rotated forward, the crosshead 23 moves forward and is separated from the mold clamping housing 14. On the other hand, when the screw shaft 25 shown in FIG. 3B is reversely rotated, the crosshead 23 moves backward and approaches the mold clamping housing 14.

From another point of view, when the screw shaft 25 rotates, the facing distance D between the mold clamping housing 14 and the crosshead 23 changes. More specifically, when the screw shaft 25 is rotated forward, the facing distance D between the mold clamping housing 14 and the crosshead 23 increases. On the other hand, when the screw shaft 25 is reversely rotated, the facing distance D between the mold clamping housing 14 and the crosshead 23 decreases.

<Cover Member>

The mold clamping mechanism 20 is provided with a cylindrical cover member 40 that houses the screw shaft 25. The cover member 40 includes a rear cover member 50 that houses a part of the screw shaft 25 in the longitudinal direction and a front cover member 60 that houses the other part (remainder) of the screw shaft 25 in the longitudinal direction. From another point of view, the screw shaft 25 is covered by the rear cover member 50 and the front cover member 60. However, the ratio between the part covered by the rear cover member 50 and the part covered by the front cover member 60 changes as the crosshead 23 moves.

However, the screw shaft 25 is always entirely covered by the cover member 40 regardless of the position of the crosshead 23, and the screw shaft 25 is never exposed to the outside of the cover member 40. More specifically, a part of the screw shaft 25 protruding to the rear side of the crosshead 23 (toward the mold clamping housing) is always covered by the rear cover member 50. Further, a part of the screw shaft 25 protruding to the front side of the crosshead 23 (toward the movable platen) is always covered by the front cover member 60.

In the following description, the part of the screw shaft 25 that protrudes to the rear side of the crosshead 23 and is covered by the rear cover member 50 is referred to as a “rear-side protrusion” and the other part of the screw shaft 25 that protrudes to the front side of the crosshead 23 and is covered by the front cover member 60 is referred to as a “front-side protrusion” in some cases. As already mentioned, the lengths of the rear-side protrusion and the front-side protrusion change as the crosshead 23 moves.

<Rear Cover Member>

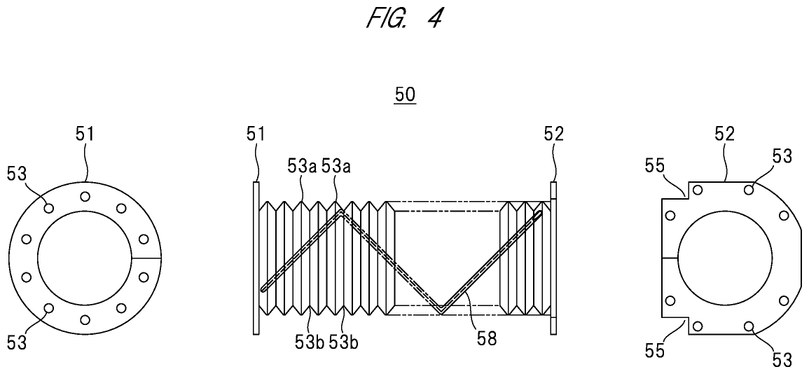

The rear cover member 50 is arranged between the mold clamping housing 14 and the crosshead 23. FIG. 4 is an explanatory diagram showing the rear cover member 50. The rear cover member 50 of the present embodiment is a bellows tube made of resin. A flange 51 is provided at one end of the rear cover member 50 and a flange 52 is provided at the other end. Further, a plurality of peaks (projections) 53a and valleys (recesses) 53b are alternately provided between the flanges 51 and 52.

The flange 51 is fixed to the mold clamping housing 14, and the flange 52 is fixed to the crosshead 23. More specifically, the flange 51 is fixed to a front surface 14f of the mold clamping housing 14 that faces the crosshead 23. The flange 52 is fixed to a back surface 23b of the crosshead 23 that faces the mold clamping housing 14. From another point of view, one surface of the mold clamping housing 14 that faces the crosshead 23 is the front surface 14f of the mold clamping housing 14. Also, one surface of the crosshead 23 that faces the mold clamping housing 14 is the back surface 23b of the crosshead 23 (FIG. 3A and FIG. 3B).

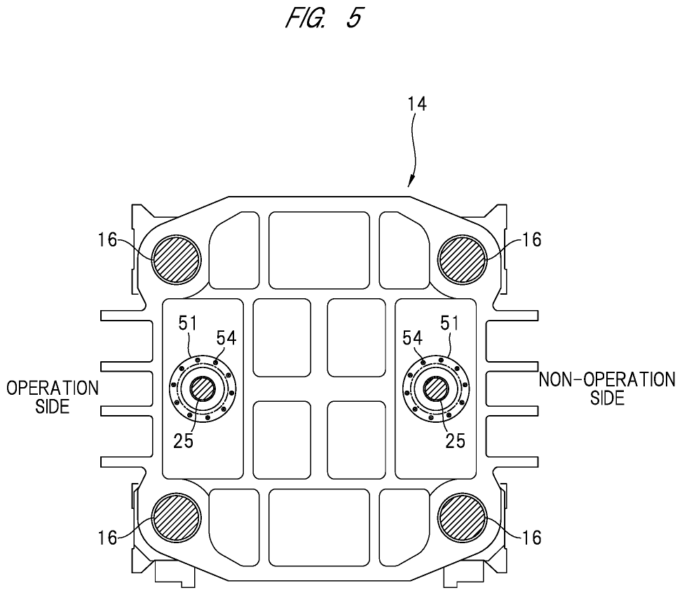

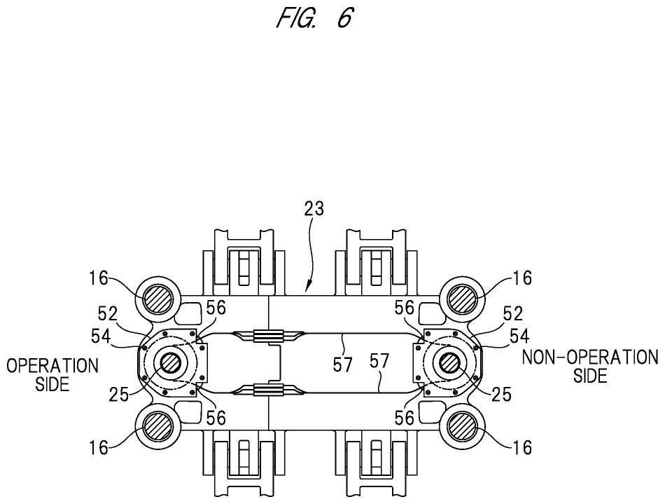

FIG. 5 is a plan view showing details of the front surface 14f of the mold clamping housing 14 to which the flange 51 is fixed. FIG. 6 is a plan view showing details of the back surface 23b of the crosshead 23 to which the flange 52 is fixed. A plurality of through holes 53 are formed in the flanges 51 and 52 along the circumferential direction. The flange 51 is fixed to the front surface 14f of the mold clamping housing 14 by bolts 54 inserted through the through holes 53, respectively. Also, the flange 52 is fixed to the back surface 23b of the crosshead 23 by bolts 54 inserted through the through holes 53, respectively.

As shown in FIG. 3A and FIG. 3B, the rear cover member 50, which is a bellows tube with one end fixed to the mold clamping housing 14 and the other end fixed to the crosshead 23, expands and contracts as the crosshead 23 moves. More specifically, the full length of the rear cover member 50 expands and contracts in accordance with the change in the facing distance D between the mold clamping housing 14 and the crosshead 23 caused by the movement of the crosshead 23.

For example, when the crosshead 23 moves forward by the forward rotation of the screw shaft 25 and the facing distance D between the mold clamping housing 14 and the crosshead 23 increases, the rear cover member 50 is stretched (FIG. 3A→FIG. 3B). On the other hand, when the crosshead 23 moves backward by the reverse rotation of the screw shaft 25 and the facing distance D between the mold clamping housing 14 and the crosshead 23 decreases, the rear cover member 50 is compressed (FIG. 3B→FIG. 3A).

As shown in FIG. 4, the flange 51 is circular or substantially circular, while the flange 52 is non-circular. More specifically, the flange 52 is provided with two notches 55. As a result, when the flange 52 is fixed to the back surface 23b of the crosshead 23, gaps 56 are formed between the crosshead 23 and the rear cover member 50 (flange 52) (FIG. 6). In the present embodiment, a tube 57 for supplying grease to the screw shaft 25 is drawn into the rear cover member 50 through each gap 56 formed by the notch 55. Namely, the notch 55 forms an inlet (gap 56) for drawing the pipe member (tube 57) that transports the lubricant to be supplied to the screw shaft 25 into the rear cover member 50.

The rear cover member 50 can be opened and closed. More specifically, the rear cover member 50 is provided with a fastener (zipper) 58. Therefore, it is possible to check the state of the inside (screw shaft 25) by opening the fastener 58. Moreover, only the rear cover member 50 can be detached or replaced without disassembling the mold clamping mechanism 20.

The fastener 58 of the present embodiment is spirally provided on the body of the rear cover member 50, but the fastener 58 may be provided linearly, for example. Alternatively, a fastener different from the fastener 58 may be used to enable the rear cover member 50 to be opened and closed. Further, in still another embodiment, the rear cover member 50 may be provided with a filtered vent.

<Support Member>

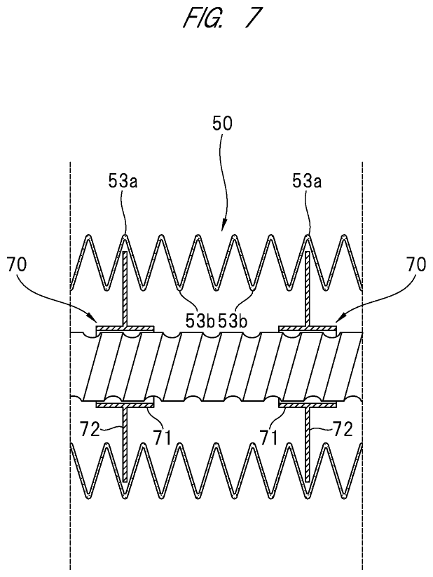

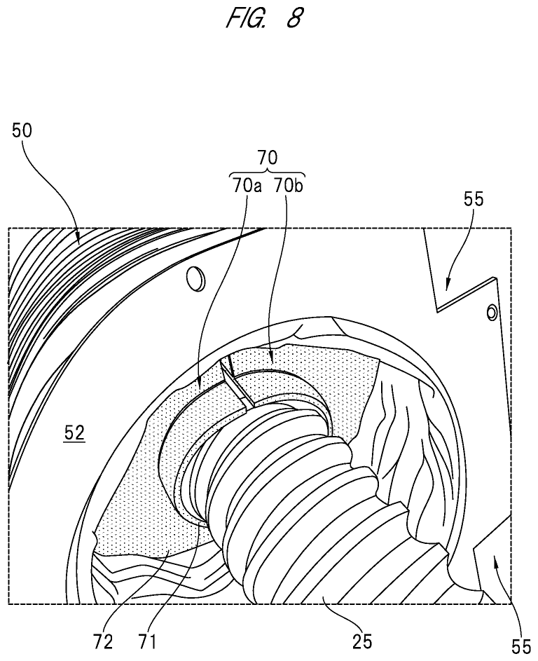

Support members 70 are provided inside the rear cover member 50. FIG. 7 is a cross-sectional view schematically showing the support members 70 arranged inside the rear cover member 50. FIG. 8 is a partial perspective view showing one of the support members 70 arranged inside the rear cover member 50.

In the present embodiment, the plurality of support members 70 are arranged inside the rear cover member 50. More specifically, three support members 70 are arranged inside the rear cover member 50. The support members 70 are arrayed in a row in the longitudinal direction of the screw shaft 25. Each support member 70 includes a cylindrical portion 71 through which the screw shaft 25 is inserted and a plate-like connecting portion 72 extending radially outward from the cylindrical portion 71.

The connecting portion 72 is circular, and its edge is inserted to an inner side of the peak 53a of the rear cover member 50. As a result, the forward and backward movement of the support member 70 is restricted. Further, the edge of the connecting portion 72 inserted to the inner side of the peak 53a is fixed to the rear cover member 50. A fixing method of the connecting portion 72 is not particularly limited. For example, the edge of the connecting portion 72 is caulked and fixed to the rear cover member 50.

The support member 70 prevents the rear cover member 50 from bending or deforming. In particular, the support member 70 effectively prevents the rear cover member 50 from bending due to its own weight when the rear cover member 50 is stretched. From another point of view, the interference between the rear cover member 50 and the screw shaft 25 is effectively prevented.

The support member 70 is composed of two or more members that are separable in the radial direction of the cylindrical portion 71. More specifically, the support member 70 is composed of a pair of half-split members 70a and 70b separable in the radial direction of the cylindrical portion 71.

The half-split members 70a and 70b are separated when the rear cover member 50 is opened. Therefore, although the support member 70 is fixed to the rear cover member 50, it does not hinder the opening and closing of the rear cover member 50. On the other hand, the half-split members 70a and 70b are united to form the support member 70 when the rear cover member 50 is closed. Note that “united” mentioned here does not mean that the half-split members 70a and 70b are integrated. The “united” mentioned here means a state in which the end surfaces of the half-split members 70a and 70b are abutted against each other or a state in which they face each other with almost no gap.

The number and intervals of the support members 70 can be changed as appropriate in accordance with the length and thickness of the rear cover member 50. Also, the support member 70 can be omitted. For example, the support member 70 may be omitted if the rear cover member 50 has sufficient strength to retain its own shape.

<Front Cover Member>

With reference to FIG. 3A and FIG. 3B, the front cover member 60 is arranged between the crosshead 23 and the movable platen 15. The front cover member 60 is a cylindrical tube made of resin having an inner diameter large enough for the screw shaft 25 to move in and out. One end (proximal end) of the front cover member 60 is opened, and the other end (distal end) of the front cover member 60 is closed.

The proximal end of the front cover member 60 is fixed to the crosshead 23. On the other hand, the distal end of the front cover member 60 is not fixed to anything. Namely, the front cover member 60 is cantilevered.

The proximal end of the front cover member 60 is fixed to the front surface 23f of the crosshead 23 (one surface of the crosshead 23 opposite to the back surface 23b) by bolts. Also, the front cover member 60 communicates with the nut member 26 provided in the crosshead 23.

The centers of the screw shaft 25, the rear cover member 50, the nut member 26, and the front cover member 60 are located on a common straight line. In other words, the screw shaft 25, the rear cover member 50, the nut member 26, and the front cover member 60 are coaxial.

The front cover member 60 fixed to the crosshead 23 moves forward and backward together with the crosshead 23. A part of the screw shaft 25 protruding to the front side of the crosshead 23 as the crosshead 23 moves is covered by the front cover member 60. From another point of view, the front-side protrusion of the screw shaft 25 enters the front cover member 60.

The length of the front-side protrusion of the screw shaft 25 changes (increases or decreases) as the crosshead 23 moves. More specifically, the length of the front-side protrusion increases when the crosshead 23 moves backward, and the length of the front-side protrusion decreases when the crosshead 23 moves forward. From another point of view, the length of the part of the screw shaft 25 entering the front cover member 60 increases when the crosshead 23 moves backward, and the length of the part of the screw shaft 25 entering the front cover member 60 decreases when the crosshead 23 moves forward.

The full length of the front cover member 60 is longer than the length of the front-side protrusion when the crosshead 23 moves backward to the maximum. Therefore, the front cover member 60 does not abut against the screw shaft 25 even when the crosshead 23 moves backward to the position where the length of the front-side protrusion is the longest.

On the other hand, the full length of the front cover member 60 is shorter than the facing distance between the crosshead 23 and the movable platen 15 when the crosshead 23 moves forward to the maximum. Therefore, the front cover member 60 does not abut against the movable platen 15 even when the crosshead 23 moves forward to the position where the length of the front-side protrusion is the shortest.

As described above, in the present embodiment, the screw shaft 25 constituting the mold clamping mechanism 20 is always covered by the cover member 40. Therefore, the reduction in the life of the screw shaft 25 and the early breakage of the screw shaft 25 can be prevented even if the mold clamping apparatus 2 including the mold clamping mechanism 20 or the injection molding machine 1 including the mold clamping apparatus 2 is used in an adverse environment. For example, it is possible to prevent the reduction in the life of the screw shaft 25 and the breakage of the screw shaft 25 due to the mold release agent, burrs, resin powder, and other foreign matters adhering to the screw shaft 25.

In addition, since the cover member 40 (the rear cover member 50 and the front cover member 60) is detachable, the maintenance of the screw shaft 25 and the nut member 26 is easy, and the replacement of the cover member 40 is also easy. In particular, since the rear cover member 50 can be opened and closed, maintenance and checking of the screw shaft 25 and the nut member 26 can be performed without detaching the rear cover member 50.

In the foregoing, the invention made by the inventor of this application has been concretely described based on the embodiment. However, it is needless to say that the present invention is not limited to the above-described embodiment and various modifications can be made within the range not departing from the gist thereof. For example, the shape, size, material, and others of the rear cover member 50 and the front cover member 60 can be changed as appropriate. Also, the injection apparatus 3 can be replaced with an injection apparatus (resin injection apparatus) that injects molten resin into the molds 11 and 12 attached to the mold clamping apparatus 2.

In the above embodiment, one set of links and ball screw is provided on each of an operation side and a non-operation side of the mold clamping apparatus 2. However, an embodiment in which one set of links and ball screw is provided at the center of the mold clamping apparatus is also conceivable. Further, an embodiment in which the links constituting the mold clamping mechanism are not divided on the operation side and the non-operation side is also conceivable. cm What is claimed is:

1. A mold clamping apparatus comprising a fixed platen and a movable platen to which a mold is respectively attached and a mold clamping mechanism configured to move the movable platen with respect to the fixed platen,
wherein the mold clamping mechanism includes:
a screw shaft configured to be rotationally driven;
a crosshead configured to move as the screw shaft rotates; and
a cylindrical cover member configured to house the screw shaft,
wherein the cover member includes a first cover member arranged between a mold clamping housing that rotatably holds the screw shaft and the crosshead and a second cover member arranged between the crosshead and the movable platen, and
wherein the first cover member expands and contracts in accordance with a change in a facing distance between the mold clamping housing and the crosshead caused by movement of the crosshead.

2. The mold clamping apparatus according to claim 1,
wherein the first cover member is a bellows tube, and the second cover member is a cylindrical tube.

3. The mold clamping apparatus according to claim 2,
wherein one end of the first cover member is fixed to a front surface of the mold clamping housing and the other end of the first cover member is fixed to a back surface of the crosshead facing the front surface of the mold clamping housing, and
wherein one end of the second cover member is fixed to a front surface of the crosshead opposite to the back surface thereof.

4. The mold clamping apparatus according to claim 3,
wherein the first cover member includes a first flange fixed to the front surface of the mold clamping housing and a second flange fixed to the back surface of the crosshead,
wherein a notch is provided in the second flange, and
wherein the notch forms an inlet for drawing a pipe member for transporting lubricant to be supplied to the screw shaft into an inside of the first cover member.

5. The mold clamping apparatus according to claim 1,
wherein the first cover member can be opened and closed.

6. The mold clamping apparatus according to claim 1, further comprising a support member arranged inside the first cover member,
wherein the support member includes a cylindrical portion through which the screw shaft is inserted and a connecting portion extending radially outward from the cylindrical portion and fixed to the first cover member.

7. The mold clamping apparatus according to claim 6,
wherein the support member is composed of two or more members separable from each other.

8. An injection molding machine composed of a mold clamping apparatus to which molds are attached and an injection apparatus configured to inject molten metal or molten resin into the molds,
wherein the mold clamping apparatus includes:
a fixed platen and a movable platen each having the mold attached thereto; and
a mold clamping mechanism configured to move the movable platen with respect to the fixed platen,
wherein the mold clamping mechanism includes:
a screw shaft configured to be rotationally driven;
a crosshead configured to move as the screw shaft rotates; and
a cylindrical cover member configured to house the screw shaft,
wherein the cover member includes a first cover member arranged between a mold clamping housing that rotatably holds the screw shaft and the crosshead and a second cover member arranged between the crosshead and the movable platen, and
wherein the first cover member expands and contracts in accordance with a change in a facing distance between the mold clamping housing and the crosshead caused by movement of the crosshead.

9. The injection molding machine according to claim 8,
wherein the first cover member is a bellows tube and the second cover member is a cylindrical tube.
